(19) United States
(12) Patent Application Publication
(10) Pub. No.: US 2025/0226621 A1
(43) Pub. Date: Jul. 10, 2025

(54) PLUG ELECTRICAL CONNECTOR AND ELECTRICAL CONNECTOR COMBINATION HAVING THE SAME

(71) Applicant: Dongguan Kangxiang Electronic Co., Ltd, Guangdong Province (CN)

(72) Inventors: MING LUO, Dongguan (CN); YUNG- CHANG LIN, Dongguan (CN); YU-HUNG LIN, Dongguan (CN); HUNG-TIEN CHANG, Dongguan (CN); HSUAN HO CHUNG, Dongguan (CN)

(21) Appl. No.: 18/981,845

(22) Filed: Dec. 16, 2024

(30) Foreign Application Priority Data
Jan. 10, 2024 (TW) 113101112

(51) Int. Cl. H01R 13/71; H01R 12/70; H01R 13/6471; H01R 13/6597

(52) U.S. Cl. CPC H01R 13/71; H01R 12/707; H01R 13/6471; H01R 13/6597

(57) ABSTRACT

A plug electrical connector and an electrical connector combination having the same are disclosed. The plug electrical connector includes a plug insulation structure; a plurality of plug terminals joined to the plug insulation structure; a movable member movably disposed on the plug insulation structure; at least one contact terminal joined to the movable member; wherein the at least one contact terminal and the movable member move simultaneously between a contact position and a retreat position. The electrical connector combination includes the aforementioned plug electrical connector and a receptacle electrical connector. The receptacle electrical connector includes a receptacle insulation structure; a plurality of receptacle terminals joined to the receptacle insulation structure; at least one detecting terminal joined to the receptacle insulation structure. The contact terminal is selectively to contact the detecting terminal, whereby certain specific functions of an electronic device are activated.

### BACKGROUND OF THE INVENTION

### Field of the Invention

The invention relates to a technical filed of electrical connector, and more particularly to a plug electrical connector and an electrical connector combination having the same.

### Description of the Related Art

Electrical connectors are used to electrically connect electronic devices and electronic modules for transmission of electronic signals or electrical power. The electronic signals or the electrical power are transmitted through the mating of the terminals of the electrical connector with the terminals of its counterpart electrical connector. Therefore, certain functions of the electronic device are always to be activated when the electrical connectors mate each other.

### BRIEF SUMMARY OF THE INVENTION

An object of the present invention is to provide a plug electrical connector and an electrical connector combination having the same, wherein certain functions of an electronic device or an electronic module are selectively activated after the mating of the electrical connector combination is accomplished.

The invention provides a plug electrical connector. The plug electrical connector in accordance with an exemplary embodiment of the invention includes a plug insulation structure; a plurality of plug terminals joined to the plug insulation structure, wherein each of the plug terminal includes a first mating portion, a first securing portion and a first soldering portion; a movable member movably disposed on the plug insulation structure; at least one contact terminal joined to the movable member; wherein the at least one contact terminal and the movable member move simultaneously between a contact position and a retreat position.

The invention provides an electrical connector combination. The electrical connector combination of in accordance with an exemplary embodiment of the invention includes the aforementioned plug electrical connector and a receptacle electrical connector. The receptacle electrical connector includes a receptacle insulation structure; a plurality of receptacle terminals joined to the receptacle insulation structure, wherein each of the receptacle terminal includes a second mating portion, a second securing portion and a second soldering portion; at least one detecting terminal joined to the receptacle insulation structure; wherein when the at least one contact terminal moves to the contact position, the at least one contact terminal contacts the at least one detecting terminal after the plug terminals mate the receptacle terminals; wherein when the at least one contact terminal moves to the retreat position, the at least one contact terminal fails to contact the at least one detecting terminal after the plug terminals mate the receptacle terminals.

The plug electrical connector of the present invention has the movable member capable of moving between the contact position and the retreat position, and at least one contact terminal joined to the movable member and moved with the movable member. When a user moves the movable member to the contact position, the contact terminal of the plug electrical connector contacts the detecting terminal of the receptacle electrical connector after the plug terminals have mated the receptacle terminals, whereby certain functions such as power transmission or signal transmission is activated. When a user moves the movable member to the retreat position, the contact terminal of the plug electrical connector fails to contact the detecting terminal of the receptacle electrical connector after the plug terminals have mated the receptacle terminals, whereby the functions are not activated.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an electrical connector combination of the present invention;

FIG. 2 is a perspective view of un-combined a plug electrical connector and a receptacle electrical connector of the electrical connector combination of FIG. 1;

FIG. 3 is an exploded view of the plug electrical connector of the electrical connector combination of FIG. 1;

FIG. 4 is an exploded view of the receptacle electrical connector of the electrical connector combination of FIG. 1;

FIG. 5 is an exploded view of plug terminals, a movable member and a first metal shielding member of the plug electrical connector of the present invention;

FIG. 6 is a perspective view of an assembly of the plug terminals, the movable member and the first metal shielding member of the plug electrical connector of the present invention;

FIG. 7 is a perspective view of an assembly of the plug terminals, the movable member and the first metal shielding member of the plug electrical connector of the present invention from another view angle;

FIG. 8 is an exploded view of the plug terminals joined to a plug insulation structure, the movable member and the first metal shielding member of the plug electrical connector of the present invention;

FIG. 9 is a perspective view of an assembly of the plug terminals joined to a plug insulation structure, the movable member and the first metal shielding member of the plug electrical connector of the present invention;

FIG. 10 is a perspective view of the plug electrical connector of the present invention;

FIG. 11 is a perspective view of receptacle terminals and the second metal shielding members of the receptacle electrical connector of the present invention;

FIG. 12 is a perspective view of the receptacle terminals and the second metal shielding members of FIG. 11 at another view angle;

FIG. 13 is a perspective view of the receptacle terminals and the second metal shielding members of FIG. 11 at another view angle;

FIG. 14 is a perspective view of an assembly of the receptacle terminals joined to a receptacle insulation structure and the second metal shielding members of the receptacle electrical connector of the present invention;

FIG. 15 is a perspective view of the receptacle electrical connector of the present invention;

FIG. 16 is a perspective view of mating of the plug electrical connector and the receptacle electrical connector, wherein a contact terminal of the plug electrical connector contacts a detecting terminal of the receptacle electrical connector;

FIG. 17 is a perspective view of mating of the plug electrical connector and the receptacle electrical connector, wherein a contact terminal of the plug electrical connector fails to contact a detecting terminal of the receptacle electrical connector;

FIG. 18 is a diagram of insertion loss versus signal frequency of the electrical connector combination of the present invention;

FIG. 19 is a diagram of return loss versus signal frequency of the electrical connector combination of the present invention;

FIG. 20 is a diagram of common mode noise versus signal frequency of the electrical connector combination of the present invention;

FIG. 21 is a diagram of crosstalk between the high frequency signal terminal pairs versus signal frequency of the electrical connector combination of the present invention;

FIG. 22 is a diagram of crosstalk between the high frequency signal terminal pair and the regular signal terminal pair of the electrical connector combination of the present invention;

FIG. 23 is a perspective view of another embodiment of the plug terminals and the first metal shielding member of the plug electrical connector;

FIG. 24 is a top view of the plug terminals and the first metal shielding member of FIG. 23;

FIG. 25 is a perspective view of yet another embodiment of the plug terminals and the first metal shielding member of the plug electrical connector; and

FIG. 26 is a top view of the plug terminals and the first metal shielding member of FIG. 25.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

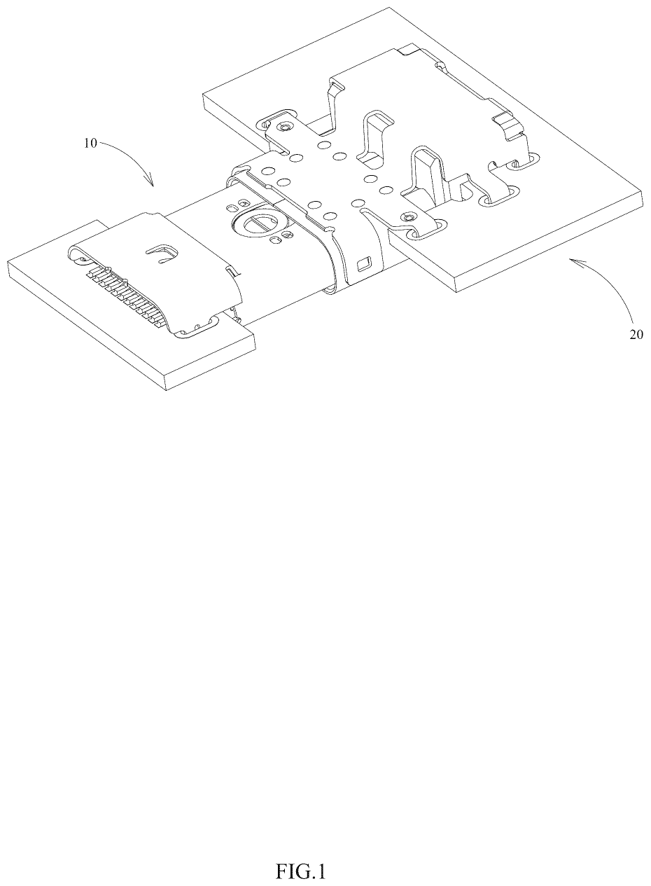

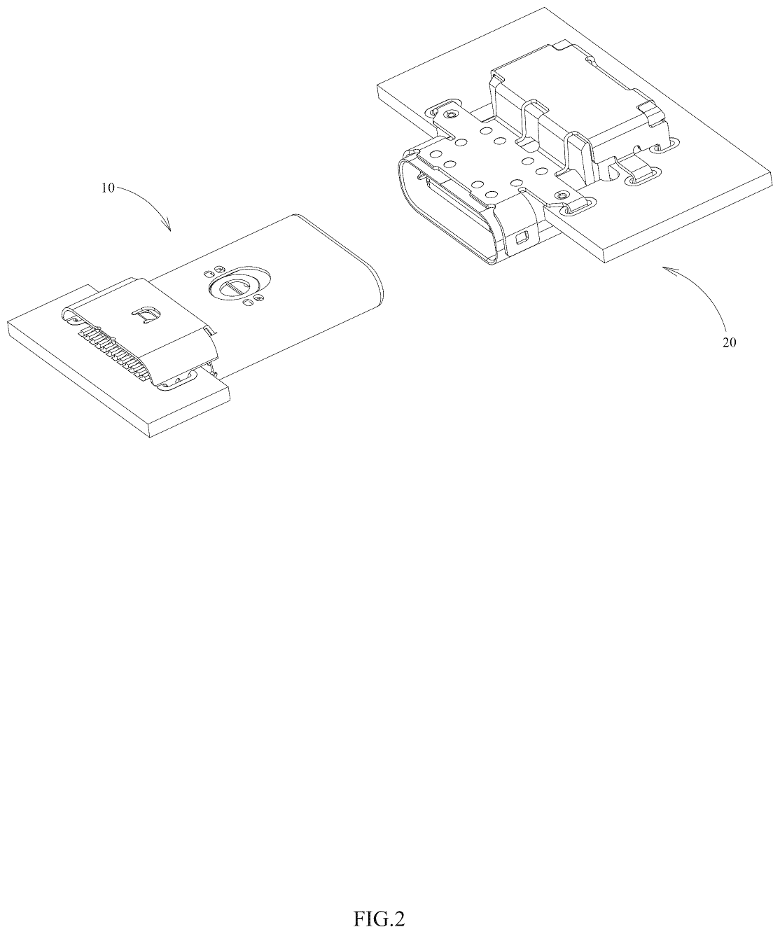

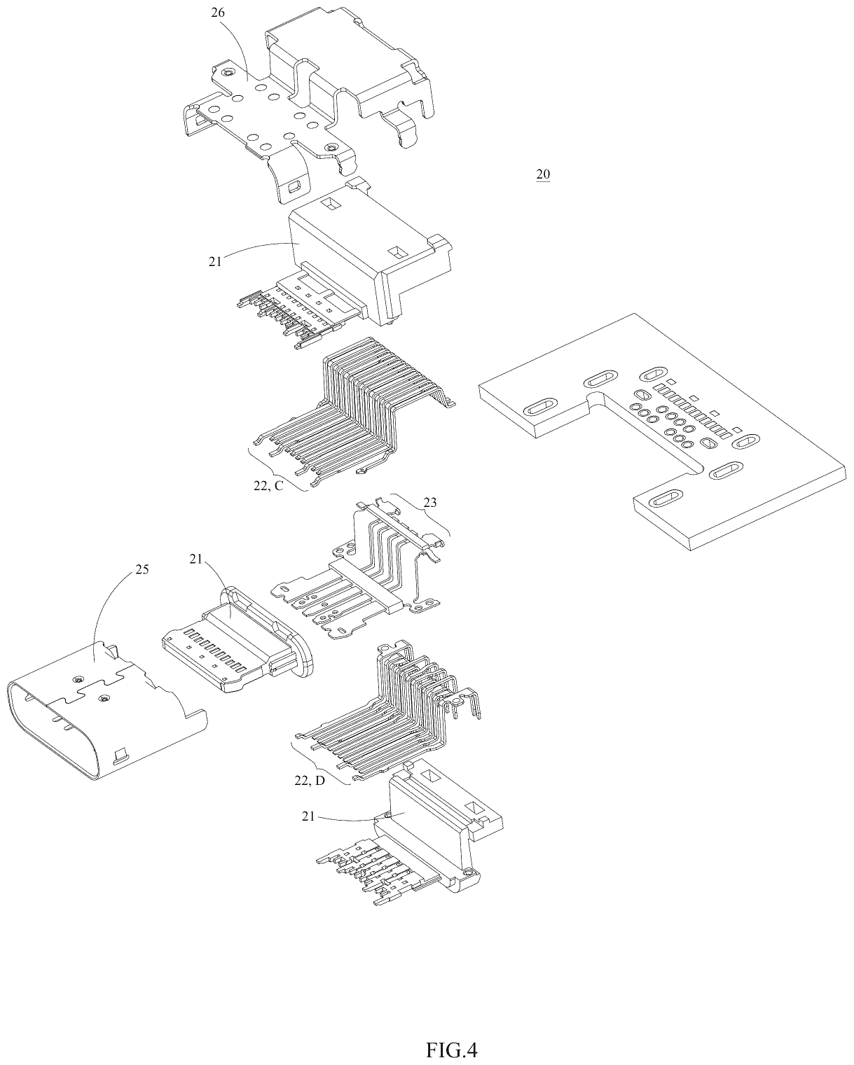

Referring to FIGS. 1, 2, 3 and 4, an embodiment of an electrical connector combination of the present invention is disclosed. The electrical connector combination 1 of the present embodiment includes a plug electrical connector 10 and a receptacle electrical connector 20. The plug electrical connector 10 mates the receptacle electrical connector 20 for electrical connection. The plug electrical connector 10 and the receptacle electrical connector 20 recited in the present embodiment complies with the specification of USB type C. However, the electrical connector combination 1 of the present invention is not limited thereto, the electrical connectors complying with other specification also apply.

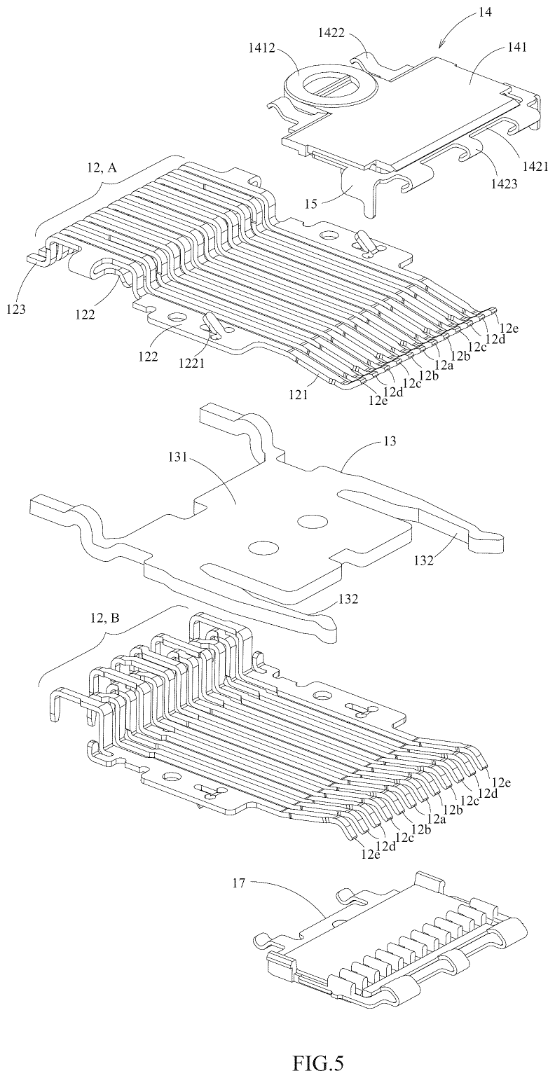

Referring to FIGS. 5, 6, 7, 8, 9 and 10, the plug electrical connector 10 includes a plug insulation structure 11, a plurality of plug terminals 12, a first metal shielding member 13, a movable member 14, at least one contact terminal 15, a plug metal housing 16 and a terminal holding member 17.

As shown in FIG. 5, the plurality of plug terminals 12 are arranged in two plug terminal rows A and B. Each of the plug terminal rows A or B includes a first regular signal terminal pair 12a, two first functional terminals 12b disposed at two opposite sides of the first regular signal terminal pair 12a, two first power terminals 12c disposed at an external side of the first functional terminals 12b respectively, two first high frequency signal terminal pairs 12d disposed at an external side of the first power terminals 12c respectively and two first ground terminals 12e disposed at an external side of the first high frequency signal terminal 12d pairs respectively. The arrangement of the plug terminal rows A and B complies with the specification of USB type C. Each plug terminal 12 has a first mating portion 121, a first securing portion 122 and a first soldering portion 123. The first mating portion 121 has a structure of curved spring arm. The first securing portion 122 of the first ground terminal 12e has a width greater than the first securing portion 122 of other plug terminals 12. The first securing portion 122 of the first ground terminal 12e also has a protrusion 1221.

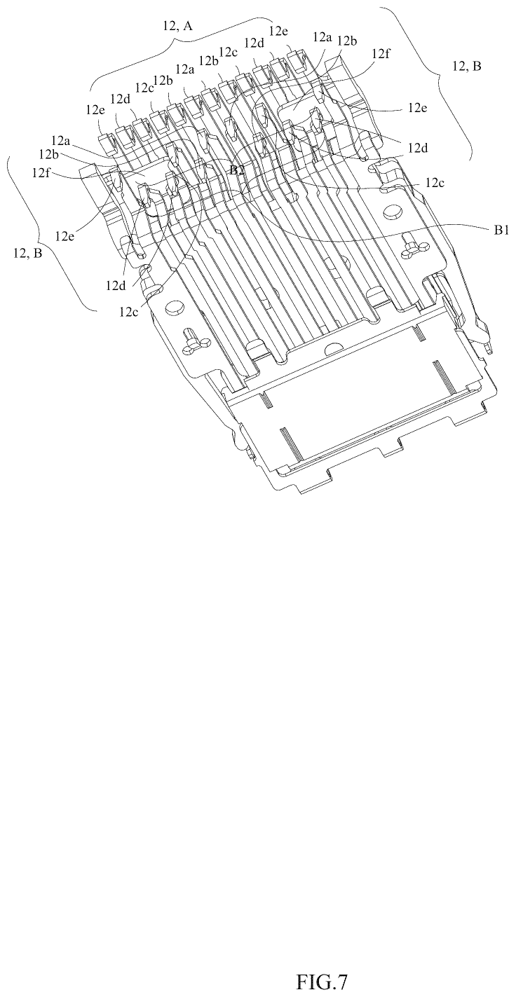

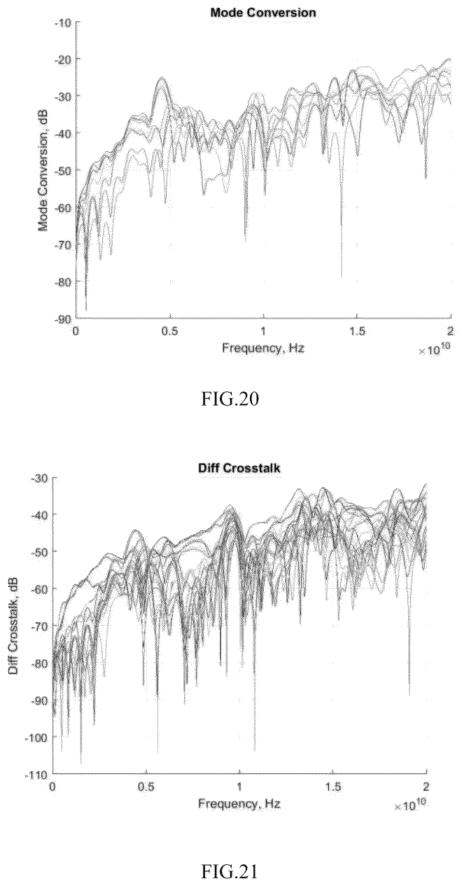

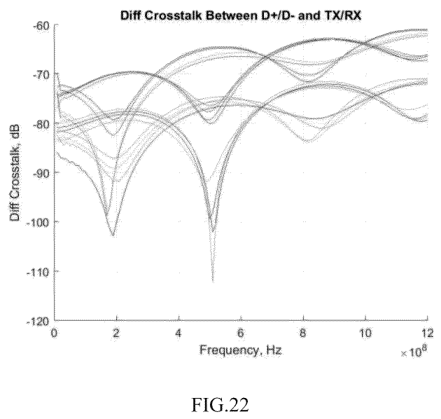

As shown in FIGS. 5 and 7, the first soldering portions 123 of all plug terminals 12 of the plug terminal row A are arranged in a row and soldered on a circuit board by the surface mounted technology (SMT). The first soldering portions 123 of the first functional terminal 12b and the first high frequency signal terminal pairs 12d of the plug terminal row B are arranged in a first plug soldering row B1, and the first soldering portions 123 of the first regular signal terminal pair 12a, the first power terminals 12c and the first ground terminals 12e are arranged in a second plug soldering row B2. The first soldering portions 123 of the first plug soldering row B1 and the first soldering portions 123 of the second plug soldering row B2 are unaligned. The first soldering portions 123 of the plug terminal row B are inserted into through holes of the circuit board and soldered therein. Therefore, the first soldering portions 123 of the plug terminal row A is separated from the first soldering portions 123 of the plug terminal row B by a larger distance to prevent crosstalk, as shown in FIGS. 21 and 22. The first soldering portions 123 of the plug terminal row B is further divided into the first plug soldering row B1 and the second plug soldering row B2 to provide an additional distance therebetween, thereby preventing low impedance. The first soldering portion 123 of the plug terminal row B is more distanced to the ground, which causes the common mode noise goes down as shown in FIG. 20.

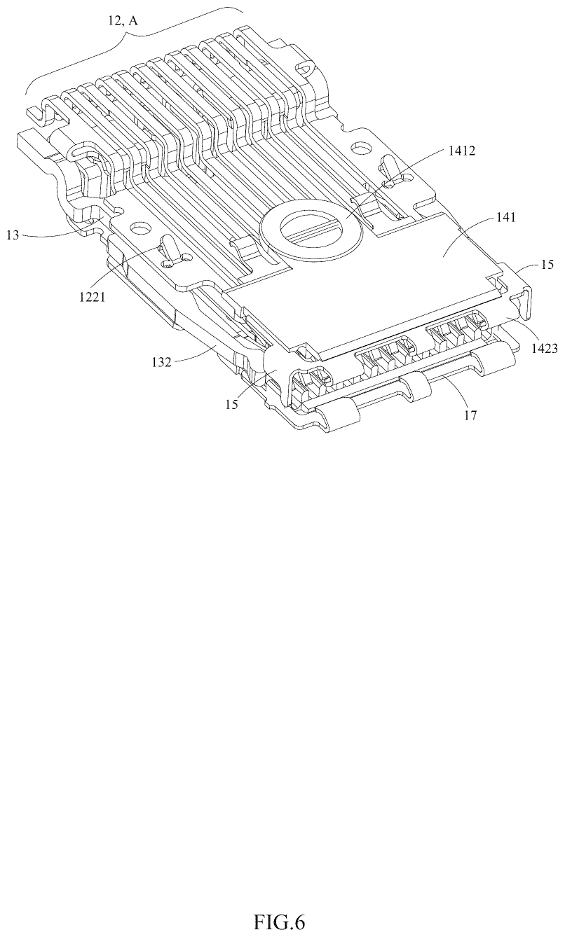

As shown in FIGS. 6 and 7, the first ground terminal 12 of the plug terminal row B has a first electromagnetic shielding portion 12f extending between the first high frequency signal terminal pairs 12d of the plug terminal row A and the first high frequency signal terminal pairs 12d of the plug terminal row B along a direction perpendicular to the plug terminal 12. The first electromagnetic shielding portion 12f has a plate like shape and curved at an end away from the first soldering portion 123. The curved end of the first electromagnetic shielding portion 12f is positioned between the first securing portions 122 of the first high frequency signal terminal pairs 12d of the plug terminal row A and the plug terminal row B. The first electromagnetic shielding portion 12f provides electromagnetic shielding effect between the first high frequency signal terminal pairs 12d of the plug terminal row A and the plug terminal row B.

As shown in FIGS. 5, 6 and 7, the first metal shielding member 13 is disposed between the plug terminals 12 of the plug terminal row A and the plug terminal row B. The first metal shielding member 13 includes a shielding main body 131 and two holding spring arms 132 disposed at two opposite sides of the shielding main body 131.

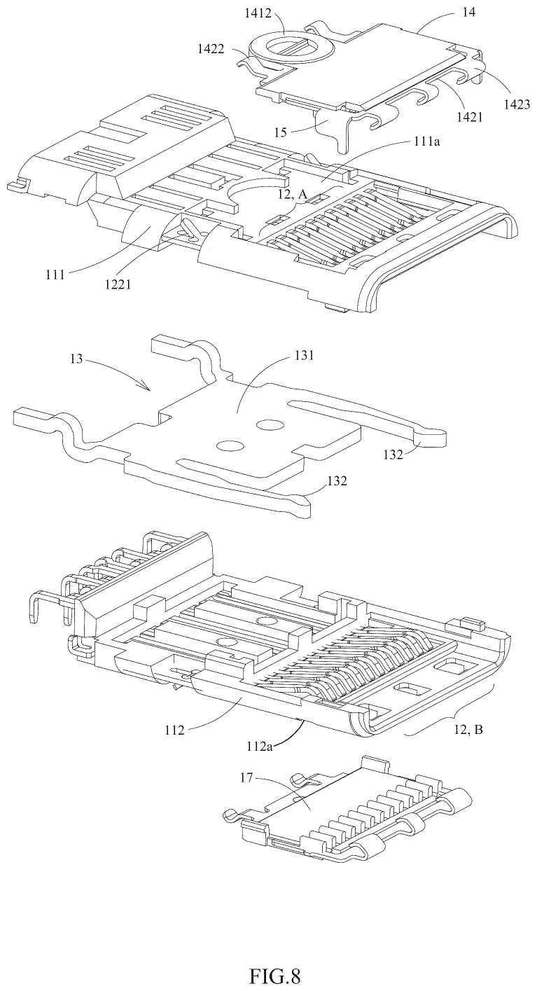

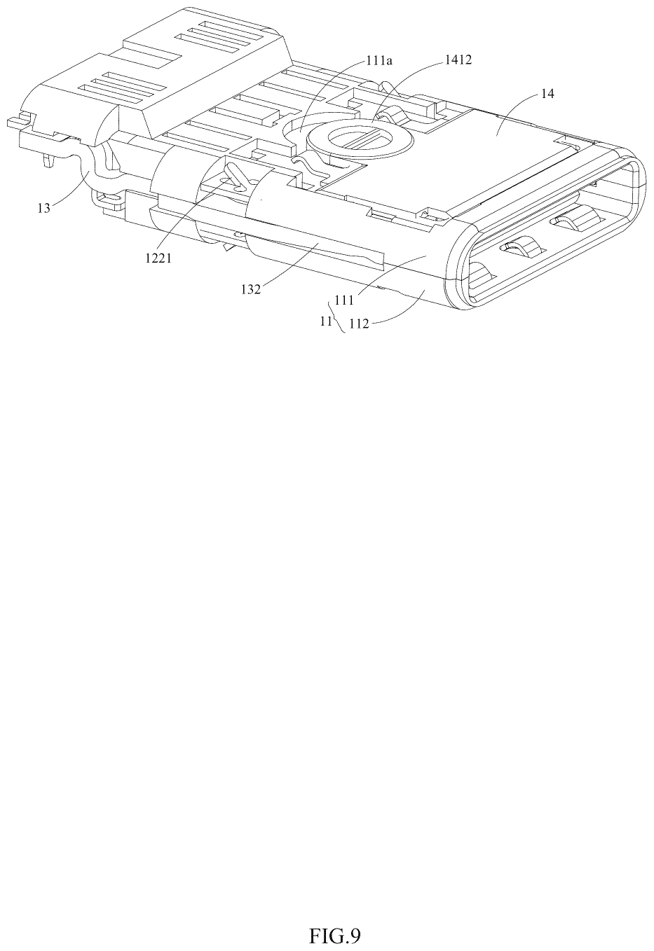

As shown in FIGS. 8 and 9, the plug terminals 12 of the plug terminal row A are joined to a first plug insulation structure 111 by the insert molding process. The plug terminals 12 of the plug terminal row B are joined to a second plug insulation structure 112 by the insert molding process. The first plug insulation structure 111 engages the second plug insulation structure 112, and the first metal shielding member 13 is sandwiched between the first plug insulation structure 111 and the second plug insulation structure 112 to constitute the plug insulation structure 11. The first plug insulation structure 111 has an accommodating depression 111a, and the second plug insulation structure 112 has an accommodating depression 112a. The movable member 14 is movably disposed in the accommodating depression 111a. The opposite edges of the accommodating depression 111a limit the movement of the movable member 14 between a contact position and a retreat position. The terminal holding member 17 is accommodated in the accommodating depression 112a.

The movable member 14 includes an insulation portion 141 and a metal structural portion 142. The insulation portion 141 is movably disposed in the accommodating depression 111a. The insulation portion 141 has a plurality of terminal grooves 1411 to accommodate the first mating portion 121 of the plug terminals 12. The metal structural portion 142 is joined to the insulation portion 141. The metal structural portion 142 includes a main body 1421 and two positioning spring arms 1422 disposed on the main body 1421 and a plurality of engaging spring arms 1423. The contact terminals are disposed on two sides of the main body 1421, whereby the contact terminals 15 are positioned at an external side of the first ground terminal 12e and behind the first mating portion 121 of the first ground terminal 12e. The contact terminal 15 and the movable member 14 move between the contact position and the retreat position simultaneously.

The terminal holding member 17 has a structure identical to the movable member 14, but the terminal holding member 17 is secured in the accommodating depression 112a.

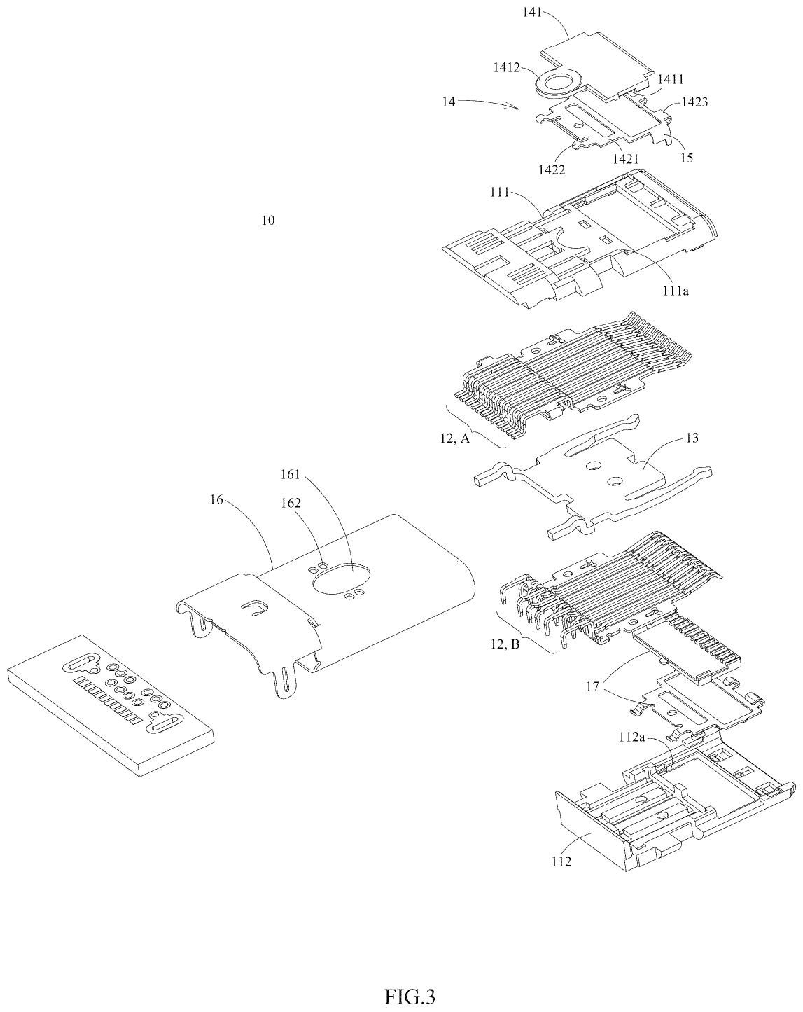

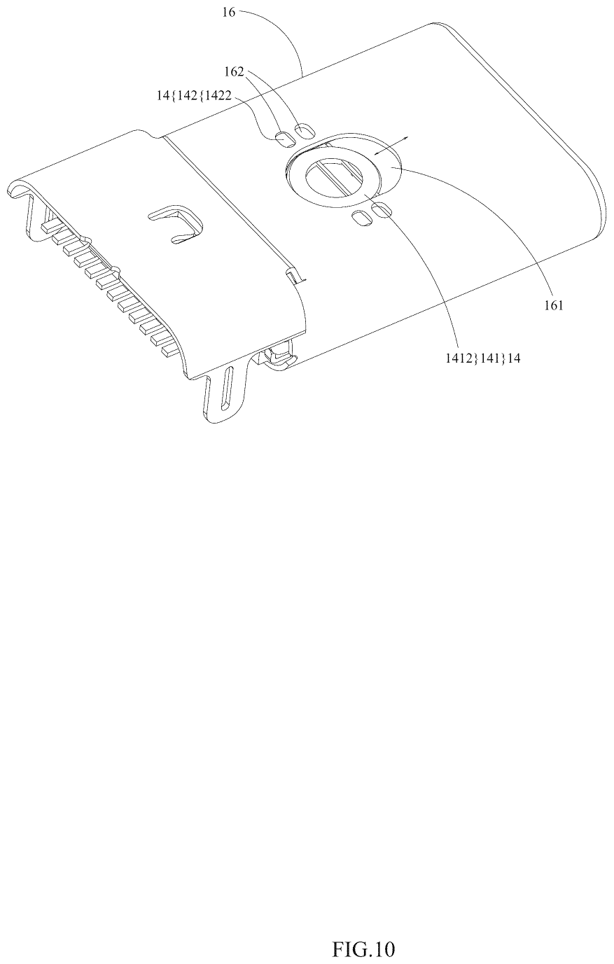

As shown in FIGS. 3 and 10, the plug metal housing 16 encloses the plug insulation structure 11. The protrusion 1221 of the first securing portion 122 of the first ground terminal 12e props against the plug metal housing 16. The plug metal housing 16 has a limiting groove 161 and two positioning holes 162. The insulation portion 141 of the movable member 14 has a limiting body 1412. The limiting body 1412 moves in the limiting groove 161 to be limited by two opposite edges of the limiting groove 161 at the contact position and the retreat position. The positioning holes 162 correspond to the contact position and the retreat position. The positioning spring arm 1422 engages the positioning holes 162 are the contact position and the retreat position respectively, whereby the movable member 14 is positioned at the contact position and the retreat position.

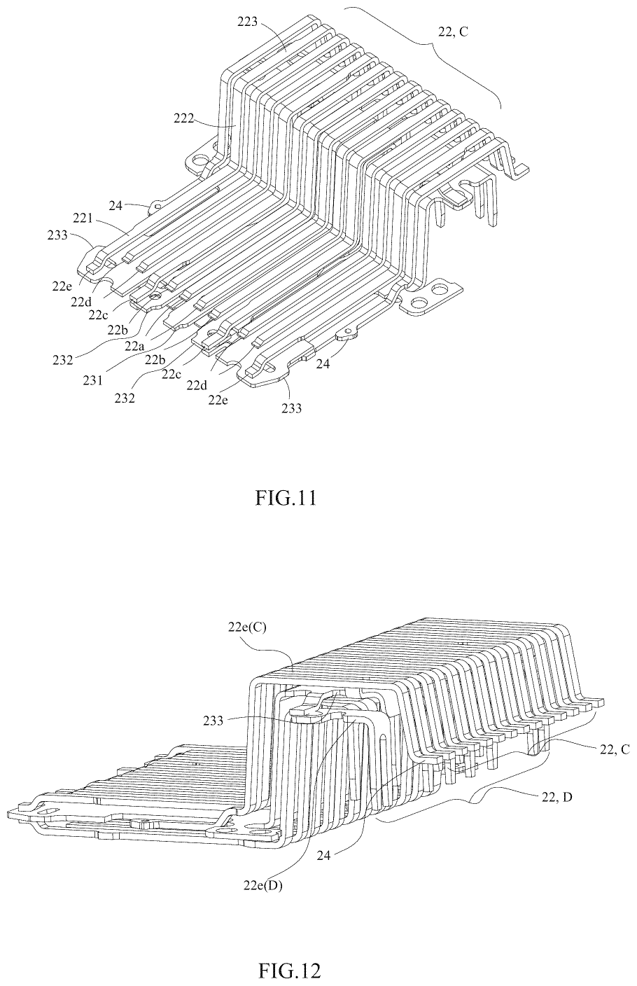

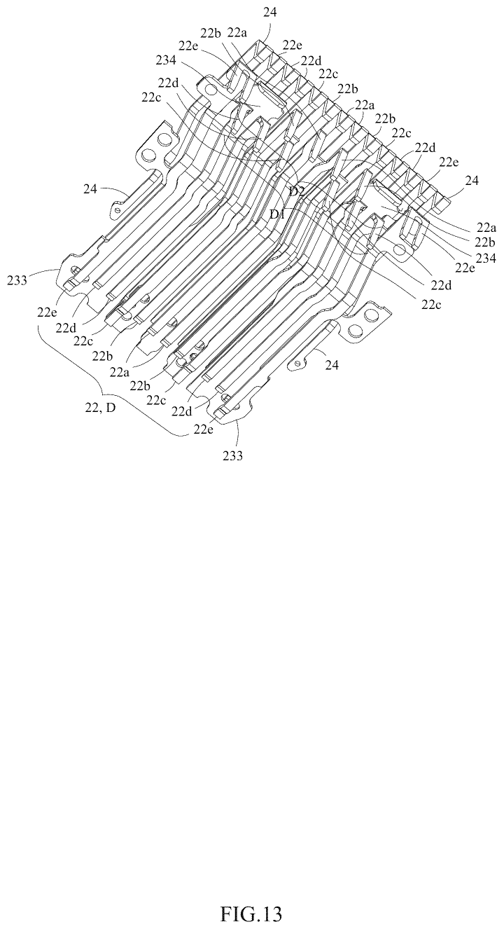

Referring to FIGS. 11, 12, 13, 14 and 15, the receptacle electrical connector 20 includes a receptacle insulation structure 21, a plurality of receptacle terminals 22, a plurality of second metal shielding member 23, at least one detecting terminal 24, a receptacle metal housing 25 and a metal reinforcing member 26.

As shown in FIGS. 11, 12 and 13, the plurality of receptacle terminals 22 are arranged in two receptacle terminal rows C and D. Each of the receptacle terminal rows C and D includes a second regular signal terminal pair 22a, two second functional terminals 22b disposed at two opposite sides of the second regular signal terminal pair 22a, two second power terminals 22c disposed at an external side of the second functional terminals 22b respectively, two second high frequency signal terminal pairs 22d disposed at an external side of the first power terminals 22c respectively and two first ground terminals 22e disposed at an external side of the second high frequency signal terminal pairs 22d respectively. Each of the receptacle terminal 22 includes a second mating portion 221, a second securing portion 222 and a second soldering portion 223.

The second soldering portions 223 of all receptacle terminals 22 of the receptacle terminal row C are arranged in a row and soldered on a circuit board by the surface mounted technology (SMT). The second soldering portions 223 of the second functional terminal 22b and the second high frequency signal terminal pairs 22d of the receptacle terminal row D are arranged in a first receptacle soldering row D1, and the second soldering portions 223 of the second regular signal terminal pair 22a, the second power terminals 22c and the second ground terminals 22e are arranged in a second receptacle soldering row D2. The second soldering portions 223 of the first receptacle soldering row D1 and the second soldering portions 223 of the second receptacle soldering row D2 are unaligned. The second soldering portions 223 of the receptacle terminal row D are inserted into through holes of the circuit board and soldered therein. Therefore, the second soldering portions 223 of the receptacle terminal row C is separated from the second soldering portions 223 of the receptacle terminal row D by a larger distance to prevent crosstalk, as shown in FIGS. 21 and 22. The second soldering portions 223 of the receptacle terminal row D is further divided into the first receptacle soldering row D1 and the second receptacle soldering row D2 to provide an additional distance therebetween, thereby preventing a low impedance therebetween. The second soldering portion 223 of the receptacle terminal row D is more distanced to the ground, which causes the common mode noise goes down as shown in FIG. 20.

The plurality of second metal shielding members 23 are separated from each other and disposed between the receptacle terminal rows C and D. The second metal shielding members 23 includes a central shielding member 231, two inner shielding members 232 disposed at tow opposite sides of the central shielding member 231, and two outer shielding members 233 disposed at an external side of the inner shielding members 232 respectively. The central shielding member 231 correspond to the second regular signal terminal pair 22a, each of the inner shielding member 232 corresponds to the second functional terminal 22b and contacts the second power terminal 22c, each of the outer shielding members 233 corresponds to the second high frequency signal terminal pair 22d and contact the second ground terminal 22e. Each of the outer shielding members 233 has a second electromagnetic shielding portion 234. The second electromagnetic shielding portion 234 has a plate like shape and curved at an end away from the second soldering portion 223. The curved end of the second electromagnetic shielding portion 234 is positioned between the second securing portions 222 of the second high frequency signal terminal pairs 22d of the receptacle terminal row C and the receptacle terminal row D. The second electromagnetic shielding portion 234 provides electromagnetic shielding effect between the second high frequency signal terminal pairs 22d of the receptacle terminal row C and the receptacle terminal row D.

The detecting terminals are disposed at an external side of the second ground terminal 22 of the receptacle terminal row C and behind the second mating portion 221 of the second ground terminal 22.

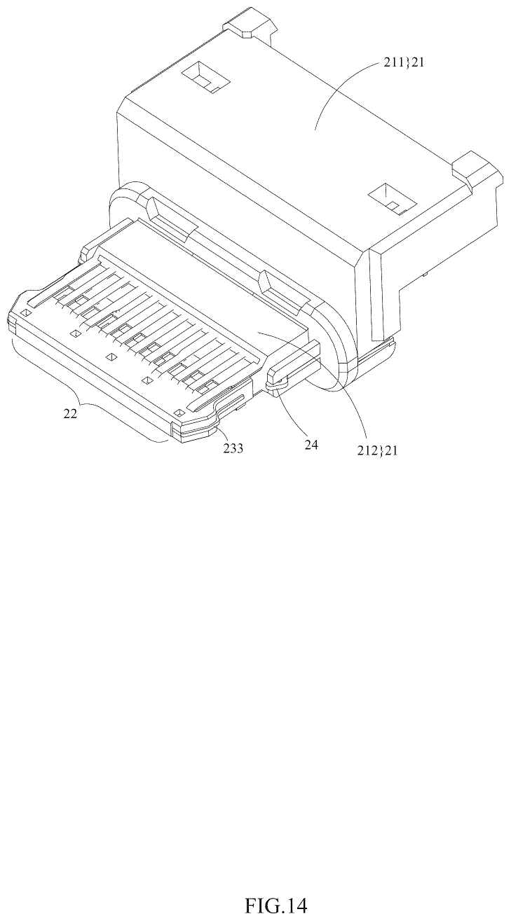

As shown in FIG. 14, the receptacle terminals 22, the detecting terminal 24 and the second metal shielding member 23 are joined to the receptacle insulation structure 20. The receptacle insulation structure 21 has a base 211 and a plate 212. The mating portions 221 of the receptacle terminals 22 of the receptacle terminal rows C and D are disposed on two opposite planes of the plate 212. The outer shielding member 233 exposed from two lateral sides of the plate 212. The detecting terminals 24 are disposed at the lateral sides and behind the second mating portions 221 of the second ground terminals 22e. The second securing portion 222 and the second soldering portion 223 of the receptacle terminals 22 are joined to the base 211.

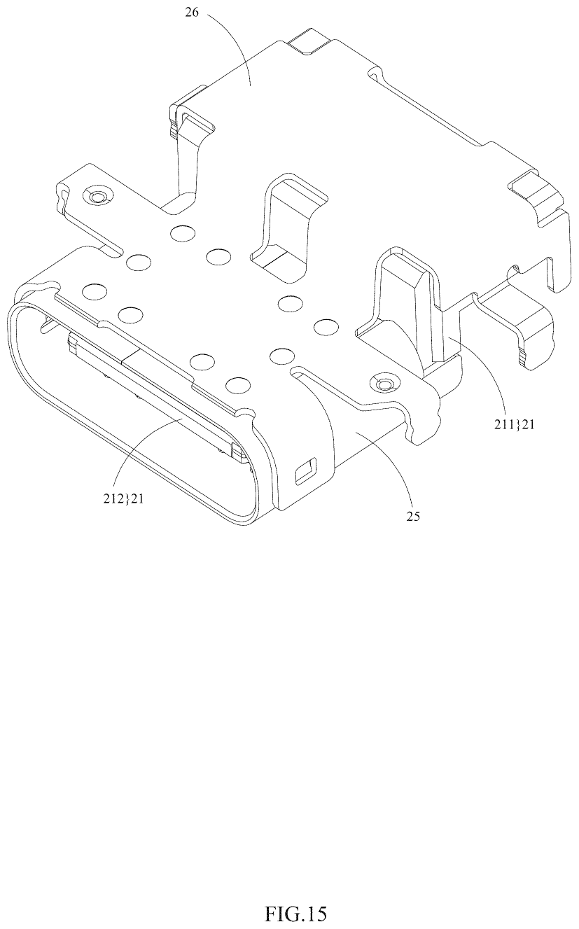

As shown in FIG. 15, the receptacle metal housing 25 is joined to the base 211 of the receptacle insulation structure 20 and surrounds the plate 212. The metal reinforcing member 26 is joined to the receptacle metal housing 25.

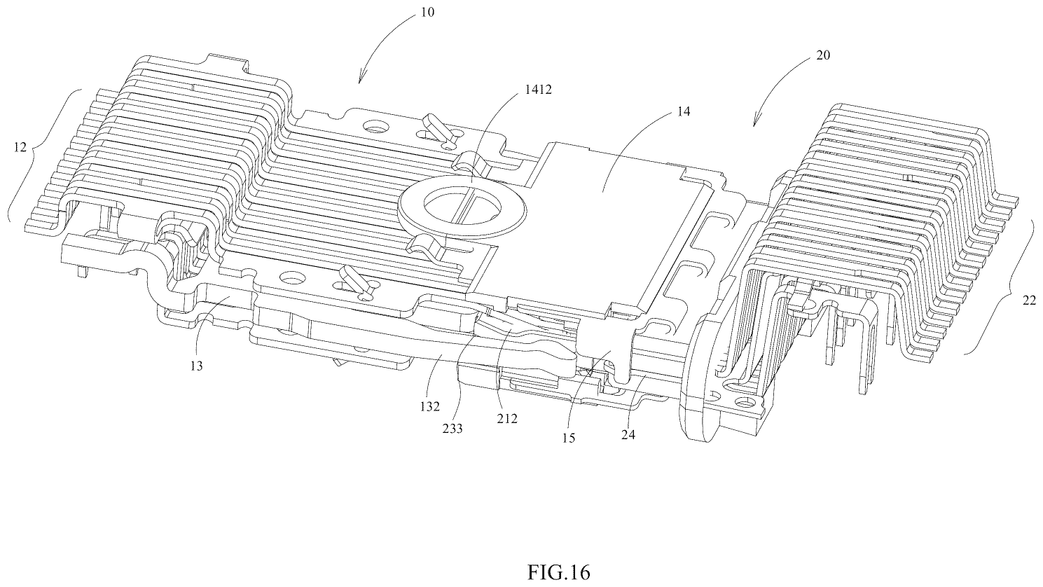

Referring to FIG. 16, when certain functions of an electronic device, such as power providing, is required after the plug electrical connector 10 mates with the receptacle electrical connector 20, a user pushes the limiting body 1412 of the movable member 14 to move the movable member 14 to the contact position. When the plug terminals 12 of the plug electrical connector 10 mates with receptacle terminals of the receptacle electrical connector 20, the holding spring arms 132 of the first metal shielding member 13 abut the outer shielding member 233 exposed from the plate 212. After the plug terminals 12 of the plug electrical connector 10 have mated with receptacle terminals of the receptacle electrical connector 20, the contact terminal 15 contacts the detecting terminal 24, whereby certain specific functions of the electronic device are activated.

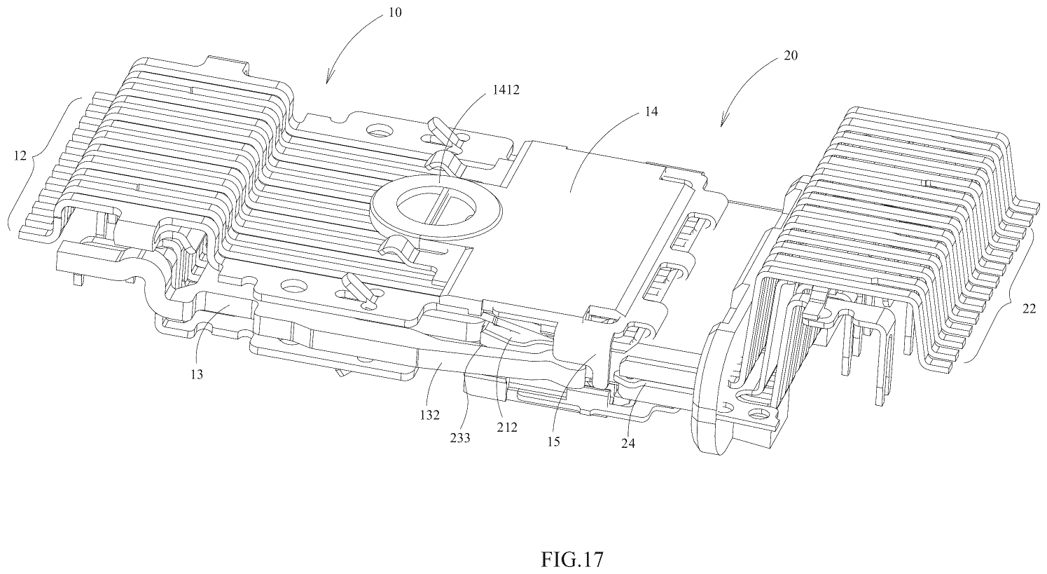

Referring to FIG. 17, when the specific functions of the electronic device are not required to be activated, the user pulls the limiting body 1412 back to move the movable member 14 back to the retreat position. After the plug terminals 12 of the plug electrical connector 10 have mated with receptacle terminals of the receptacle electrical connector 20, the contact terminal 15 fails to contact the detecting terminal 24, and the specific functions of the electronic device are not activated.

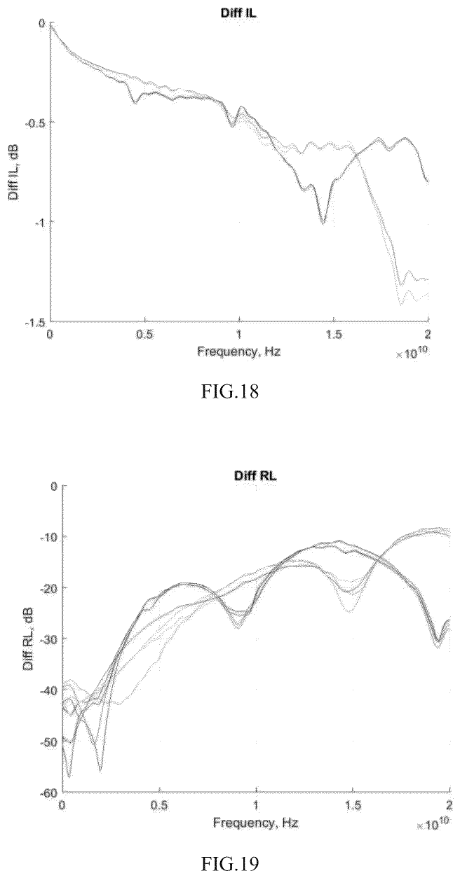

Referring to FIGS. 18 and 19, the electrical connector combination of the invention has a lower insertion loss and return loss in comparison with the conventional electrical connector combination.

Referring to FIG. 20, the electrical connector combination of the invention has a lower common mode noise in comparison with the conventional electrical connector combination.

Referring to FIGS. 21 and 22, the electrical connector combination of the invention has a lower crosstalk between high frequency signal terminal pairs and between the high frequency signal terminal pair and the regular signal terminal pair in comparison with the conventional electrical connector combination.

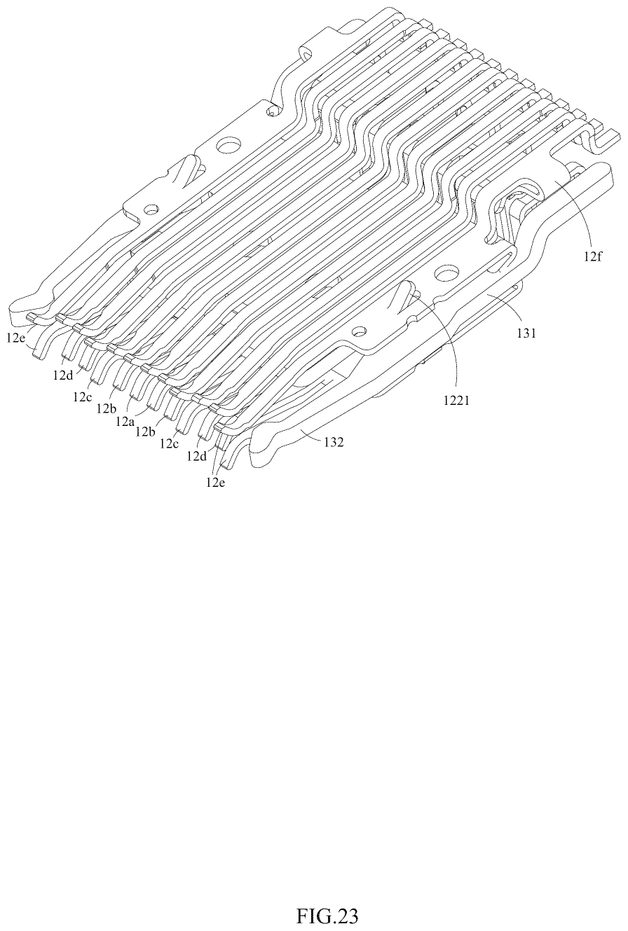

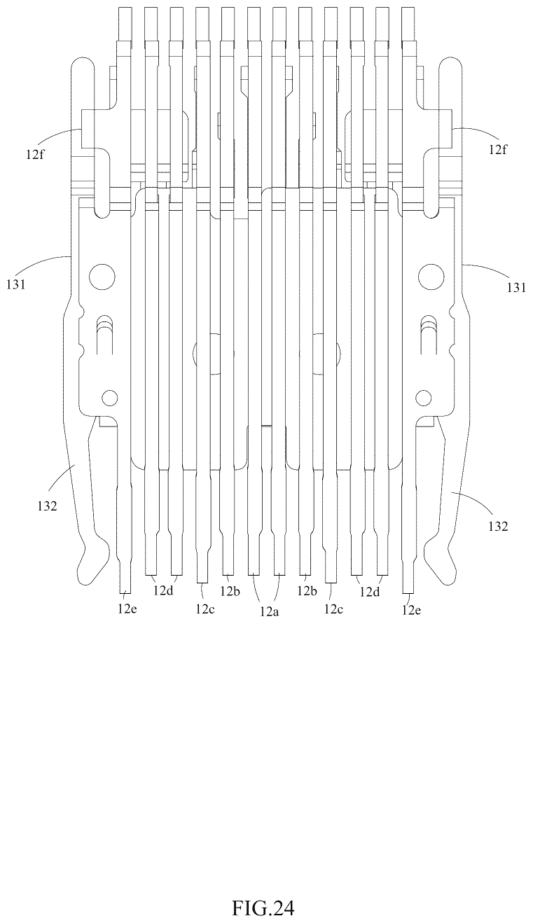

Referring to FIGS. 23 and 24, another embodiment of the plug electrical connector is disclosed. In the present embodiment, the first ground terminal 12e has a length greater than that of the first power terminal 12c, and the first power terminal 12c has a length than that of the first regular signal terminal 12a, the first functional terminal 12b and the first high frequency signal terminal 12d. The first regular signal terminal 12a, the first functional terminal 12b and the first high frequency signal terminal 12d have an identical length.

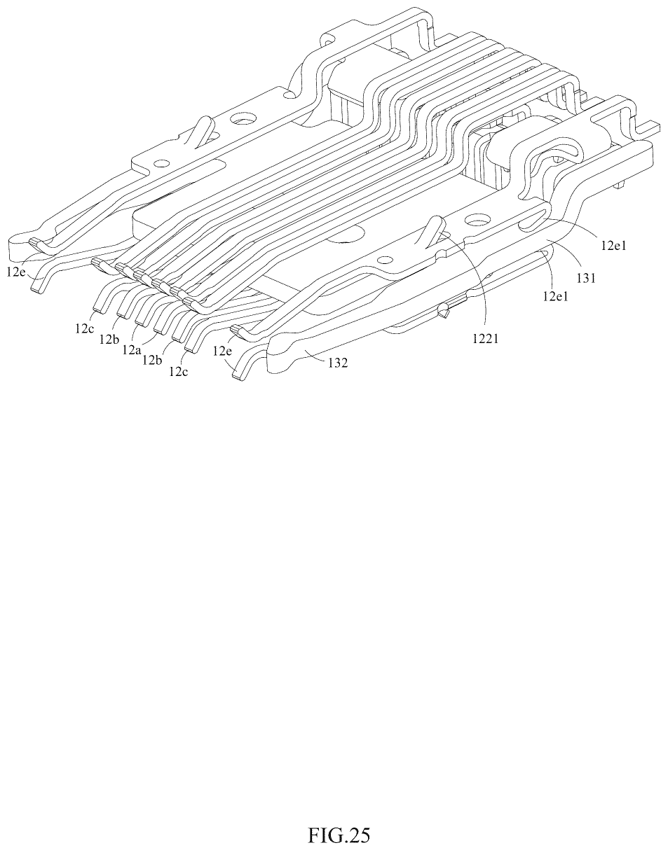

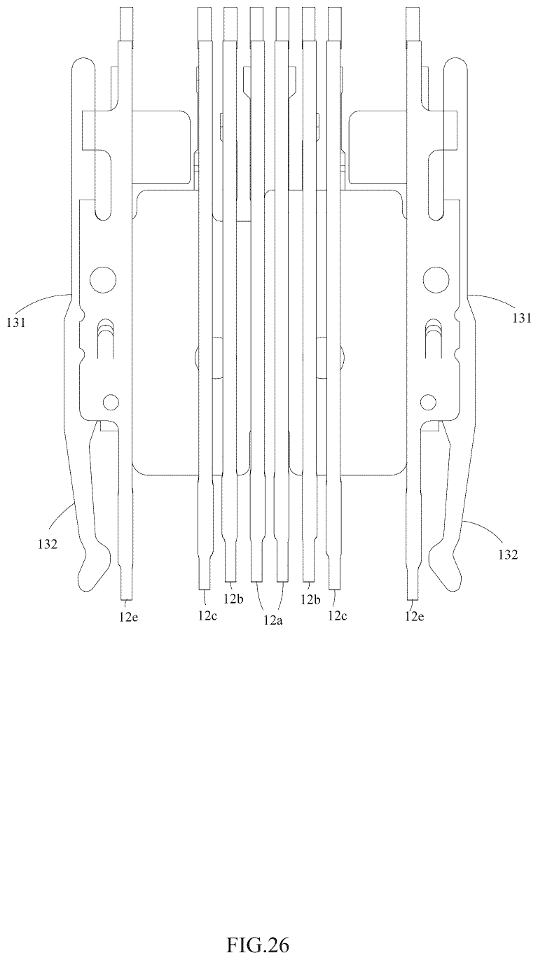

Referring to FIGS. 25 and 26, yet another embodiment of the plug electrical connector is disclosed. In the present embodiment, no high frequency signal terminal pair are presented. The plug terminals 12 includes a first regular signal terminal pair 12a, two first functional terminals 12b disposed at two opposite sides of the first regular signal terminal pair 12a, two first power terminals 12c disposed at an external side of the first functional terminals 12b respectively, and two first ground terminals 12e disposed at an external side of the first power terminal pairs 12c respectively. The first ground terminal 12e has a length greater than that of the first power terminal 12c, and the first power terminal 12c has a length greater than that of the first regular signal terminal 12a and the first functional terminal 12b. The first regular signal terminal 12a and the first functional terminal 12b have an identical length. A distance between the first ground terminal 12e and the first power terminal 12c is greater than a distance between the first power terminal 12c and the first functional terminal 12b.

The plug electrical connector of the present invention has the movable member capable of moving between the contact position and the retreat position, and at least one contact terminal joined to the movable member and moved with the movable member. When a user moves the movable member to the contact position, the contact terminal of the plug electrical connector contacts the detecting terminal of the receptacle electrical connector after the plug terminals have mated the receptacle terminals, whereby certain functions such as power transmission or signal transmission is activated. When a user moves the movable member to the retreat position, the contact terminal of the plug electrical connector fails to contact the detecting terminal of the receptacle electrical connector after the plug terminals have mated the receptacle terminals, whereby the functions are not activated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A plug electrical connector, comprising:
a plug insulation structure;
a plurality of plug terminals joined to the plug insulation structure, wherein each of the plug terminal comprises a first mating portion, a first securing portion and a first soldering portion;
a movable member movably disposed on the plug insulation structure;
at least one contact terminal joined to the movable member;
wherein the at least one contact terminal and the movable member move simultaneously between a contact position and a retreat position.

2. The plug electrical connector as claimed in claim 1, wherein the plurality of plug terminals are arranged in two plug terminal rows, and each of the plug terminal rows comprises a first regular signal terminal pair, two first functional terminals disposed at two opposite sides of the first regular signal terminal pair, two first power terminals disposed at an external side of the first functional terminals respectively, two first high frequency signal terminal pairs disposed at an external side of the first power terminals respectively and two first ground terminals disposed at an external side of the first high frequency signal terminal pairs respectively.

3. The plug electrical connector as claimed in claim 2, wherein the first soldering portions of the first high frequency signal terminal pair and the first functional terminal at one of the plug terminal rows are arranged at a first receptacle soldering row, the first soldering portions of the first regular signal terminal pair, the first power terminal and the first ground terminal at one of the plug terminal rows are arranged at a second plug soldering row, the first plug soldering row and the second plug soldering row are unaligned in a direction parallel with the plug terminals;

4. The plug electrical connector as claimed in claim 2, wherein the first ground terminal of one of the plug terminal rows has a first electromagnetic shielding portion extending between the first high frequency signal terminal pairs of the two plug terminal rows along a direction perpendicular to the plug terminals, the first electromagnetic shielding portion is curvedly disposed between the first securing portions of the two plug terminal rows.

5. The plug electrical connector as claimed in claim 2, further comprising two contact terminals disposed at an external side of the first ground terminals respectively.

6. The plug electrical connector as claimed in claim 2, further comprising a first metal shielding member disposed between two plug terminal rows, the first metal shielding member comprises two holding spring arms abutting a second metal shielding member when the plug electrical connector mates a receptacle electrical connector.

7. The plug electrical connector as claimed in claim 2, wherein the first soldering portions of the plug terminals at one of the plug terminal rows are soldered on soldering pads of a circuit board by surface mounting technology (SMT), and the first soldering portions of the plug terminals at the other plug terminal row are soldered on soldering pads of the circuit board by dual in-line package technology (DIP).

8. The plug electrical connector as claimed in claim 1, wherein the movable member comprises an insulation portion movably disposed at the plug insulation structure, and a metal structural portion joined to the insulation portion, the metal structural portion comprises a main body and at least one positioning spring arm, and the contact terminals are disposed at two opposite sides of the main body.

9. The plug electrical connector as claimed in claim 8, further comprising a plug metal housing having a limiting groove and two positioning holes, the insulation portion of the movable member has a limiting body movably disposed in the limiting groove and limited by two opposite edges thereof at the contact position and the retreat position, the positioning holes correspond to the contact position and the retreat position respectively, and the positioning spring arm engages the positioning holes when the movable member moves to the contact position and the retreat position respectively.

10. The plug electrical connector as claimed in claim 2, wherein the first ground terminal has a length greater than that of the first power terminal, and the first power terminal has a length than that of the first regular signal terminal, the first functional terminal and the first high frequency signal terminal.

11. The plug electrical connector as claimed in claim 1, wherein the plurality of plug terminals are arranged in two plug terminal rows, and each of the plug terminal row comprises a first regular signal terminal pair, two first functional terminals disposed at two opposite sides of the first regular signal terminal pair, two first power terminals disposed at an external side of the first functional terminals respectively, and two first ground terminals disposed at an external side of the first power terminal pairs respectively;
wherein the first ground terminal has a length greater than that of the first power terminal, and the first power terminal has a length greater than that of the first regular signal terminal and the first functional terminal;
wherein a distance between the first ground terminal and the first power terminal is greater than a distance between the first power terminal and the first functional terminal.

12. An electrical connector combination, comprising:
a plug electrical connector as claimed in claim 1; and
a receptacle electrical connector comprising:
a receptacle insulation structure;
a plurality of receptacle terminals joined to the receptacle insulation structure, wherein each of the receptacle terminal comprises a second mating portion, a second securing portion and a second soldering portion;
at least one detecting terminal joined to the receptacle insulation structure;
wherein when the at least one contact terminal moves to the contact position, the at least one contact terminal contacts the at least one detecting terminal after the plug terminals mate the receptacle terminals;
wherein when the at least one contact terminal moves to the retreat position, the at least one contact terminal fails to contact the at least one detecting terminal after the plug terminals mate the receptacle terminals.

13. The electrical connector combination as claimed in claim 12, wherein the plurality of receptacle terminals are arranged in two receptacle terminal rows, and each of the receptacle terminal row comprises a second regular signal terminal pair, two second functional terminals disposed at two opposite sides of the second regular signal terminal pair, two second power terminals disposed at an external side of the second functional terminals respectively, two second high frequency signal terminal pairs disposed at an external side of the first power terminals respectively and two first ground terminals disposed at an external side of the second high frequency signal terminal pairs respectively.

14. The electrical connector combination as claimed in claim 13, wherein the receptacle electrical connector comprises a plurality of second metal shielding members disposed between the receptacle terminal rows, the second metal shielding members are separated from each other, the second metal shielding members comprises a central shielding member, two inner shielding members disposed at tow opposite sides of the central shielding member, and two outer shielding members disposed at an external side of the inner shielding members respectively, the central shielding member correspond to the second regular signal terminal pair, each of the inner shielding member corresponds to the second functional terminal and contacts the second power terminal, each of the outer shielding members corresponds to the second high frequency signal terminal pair and contact the second ground terminal.

15. The electrical connector combination as claimed in claim 14, wherein the second soldering portions of the second high frequency signal terminal pair and the second functional terminal at one of the receptacle terminal rows are arranged at a first receptacle soldering row, the second soldering portions of the second regular signal terminal pair, the second power terminal and the second ground terminal at one of the receptacle terminal rows are arranged at a second receptacle soldering row, the first receptacle soldering row and the second receptacle soldering row are unaligned in a direction parallel with the receptacle terminals;

16. The electrical connector combination as claimed in claim 15, wherein each of the outer shielding members has a second electromagnetic shielding portion curvedly disposed between the second soldering portions of the second high frequency signal terminal pairs at the two receptacle terminal rows.

17. The electrical connector combination as claimed in claim 12, wherein the receptacle electrical connector comprises two detecting terminals disposed at an external side of the second ground terminals.

18. The electrical connector combination as claimed in claim 12, wherein the second soldering portions of the receptacle terminals at one of the receptacle terminal rows are soldered on soldering pads of another circuit board by surface mounting technology (SMT), and the second soldering portions of the receptacle terminals at the other receptacle terminal row are soldered on soldering pads of the other circuit board by dual in-line package technology (DIP).
